(19) United States
(12) Patent Application Publication
(10) Pub. No.: US 2012/0116855 A1
(43) Pub. Date: May 10, 2012

(54) Receiving and Recording of Content and of Timing Information

(75) Inventor: Keith Millar, W. Sussex (GB)

(73) Assignee: NDS Limited, Staines, Middlesex (GB)

(21) Appl. No.: 13/379,946

(22) PCT Filed: Jun. 29, 2009
(86) PCT No.: PCT/IB2009/052804

§ 371 Date: Jan. 17, 2012

(51) Int. Cl. G06Q 30/02; G06F 15/16

(52) U.S. Cl. 705/14.4; 709/219

(57) ABSTRACT

A method of receiving content at a user unit is disclosed. The method includes: receiving at the user unit a transmission stream, the transmission stream including: (a) a content item followed by a following content sub-item set, the following content sub-item set including one or more following content sub-items, and (b) following start time data indicating a following start point of the following content sub-item set, wherein the following start time is received in advance of the following start point during reception of the content item. The method further includes continuing to receive the following start time data periodically throughout reception of the following content sub-item set. Related methods are also disclosed.

### FIELD OF THE INVENTION

The present invention relates to a method of receiving content at a user unit; and also to a method of transmitting content to a user unit.

### BACKGROUND OF THE INVENTION

When recording digital content on a recording device such a digital video recorder, the recording device typically adds a ‘guard time’ to the beginning and end of the recording to ensure that the content to be recorded is completely recorded (i.e. to ensure that the start and/or the end of the content is not chopped off due to the content starting early or finishing late). This is a consequence of the signaling of the content start point and/or end point either not being available or being inaccurate and unreliable. For example, signaling at the content boundaries, as provided in an Event Information Table (EIT), only has an accuracy of a few seconds at best. When the content is preceded and/or followed by an advertisement/commercial break, this often results in the recording of only part of these advertisement/commercial break(s).

### SUMMARY OF THE INVENTION

There is provided in accordance with an embodiment of the present invention a method of receiving content at a user unit, the method including: receiving at the user unit a transmission stream, the transmission stream including: (a) a content item followed by a following content sub-item set, the following content sub-item set including one or more following content sub-items, and (b) following start time data indicating a following start point of the following content sub-item set, wherein the following start time is received in advance of the following start point during reception of the content item; and continuing to receive the following start time data periodically throughout reception of the following content sub-item set.

In some embodiments, the transmission stream further includes: (c) following duration data, the following duration data indicating a following duration of the following content sub-item set, and the method further includes: continuing to receive the following duration periodically throughout reception of the following content sub-item set.

In some embodiments, the transmission stream further includes: (aa) a preceding content sub-item set, the preceding content sub-item set including one or more preceding content sub-items, the preceding content sub-item set being received before the content item, and (bb) preceding start time data indicating a preceding start point of the preceding content sub-item set, wherein the preceding start time is received in advance of the preceding start point during reception of a preceding content item, the preceding content item preceding the preceding content sub-item set, and the method further includes: continuing to receive the preceding start time data periodically throughout reception of the preceding content sub-item set.

In some embodiments, the method further includes: receiving the preceding start time data at the start of reception of the content item.

In some embodiments, the transmission stream further includes: (cc) preceding duration data, the preceding duration data indicating a preceding duration of the preceding content sub-item set, and the method further includes: continuing to receive the preceding duration periodically throughout reception of the preceding content sub-item set.

In some embodiments, the method further includes: receiving the preceding duration data at the start of reception of the content item.

In some embodiments, the method further includes: making a recording at the user unit by storing a portion of the preceding content sub-item set, the content item and a portion of the following content sub-item set, wherein the recording starts at a recording start point during reception of the preceding content sub-item set and ends at a recording end point during reception of the following content sub-item set; and storing the preceding start time data, the preceding duration data, the following start time data and the following duration data.

In some embodiments, the method further includes: determining a content item start time by extracting the preceding start time data and the preceding duration data, and adding the preceding start time data to the preceding duration data to obtain the content item start time.

In some embodiments, the method further includes: playing back the recording starting from the content start time.

In some embodiments, the method further includes: determining a content item end time by extracting the following start time data and designating the following start time data as the content item end time.

In some embodiments, the method further includes: stopping playing back the recording at the content item end time.

In some embodiments, the method further includes: receiving at the user unit one or more substitution content sub-items; playing back one or more substitution content sub-items; and subsequently playing back the recording starting from the content start time.

In some embodiments, the one or more substitution content sub-items correspond to the preceding content sub-items in the preceding content sub-item set.

In some embodiments, the method further includes: receiving at the user unit one or more substitution content sub-items; and playing back one or more substitution content sub-items after playing back the recording.

In some embodiments, the one or more substitution content sub-items correspond to the following content sub-items in the following content sub-item set.

In some embodiments, the method further includes: receiving the one or more substitution content sub-items in advance; and storing the one or more substitution content sub-items.

In some embodiments, the method further includes: receiving at the user unit at least one rule defining how the recording is to be played back.

There is also provided in accordance with a further embodiment of the present invention a method of transmitting content to a user unit, the method including: transmitting to the user unit a transmission stream, the transmission stream including: (a) a content item followed by a following content sub-item set, the following content sub-item set including one or more following content sub-items, and (b) following start time data indicating a following start point of the following content sub-item set, wherein the following start time is transmitted in advance of the following start point during transmission of the content item; and continuing to transmit the following start time data periodically throughout transmission of the following content sub-item set.

In some embodiments, the transmission stream further includes: (c) following duration data, the following duration data indicating a following duration of the following content sub-item set, and the method further includes: continuing to transmit the following duration periodically throughout transmission of the following content sub-item set.

In some embodiments, the transmission stream further includes: (aa) a preceding content sub-item set, the preceding content sub-item set including one or more preceding content sub-items, the preceding content sub-item set being transmitted before the content item, and (bb) preceding start time data indicating a preceding start point of the preceding content sub-item set, wherein the preceding start time is transmitted in advance of the preceding start point during transmission of a preceding content item, the preceding content item preceding the preceding content sub-item set, and the method further includes: continuing to transmit the preceding start time data periodically throughout transmission of the preceding content sub-item set.

In some embodiments, the method further includes: transmitting the preceding start time data at the start of transmission of the content item.

In some embodiments, the transmission stream further includes: (cc) preceding duration data, the preceding duration data indicating a preceding duration of the preceding content sub-item set, and the method further includes: continuing to transmit the preceding duration periodically throughout transmission of the preceding content sub-item set.

In some embodiments, the method further includes: transmitting the preceding duration data at the start of transmission of the content item.

In some embodiments, the content sub-items include advertisements.

### BRIEF DESCRIPTION OF THE DRAWINGS AND THE APPENDICES

The present invention will be understood and appreciated more fully from the following detailed description, taken in conjunction with the drawings in which:

FIG. 1 is a simplified pictorial illustration of broadcast system constructed and operative in accordance with embodiments of the present invention;

FIG. 2 is a simplified pictorial illustration of a recording and its relationship to content and advertisement breaks in accordance with embodiments of the present invention; and

Appendix A is a copy of the “Digital Program Insertion Cueing Message for Cable” standard published by The Society of Cable Telecommunication Engineers as ANSI/SCTE 35 2007.

### DETAILED DESCRIPTION OF EMBODIMENTS

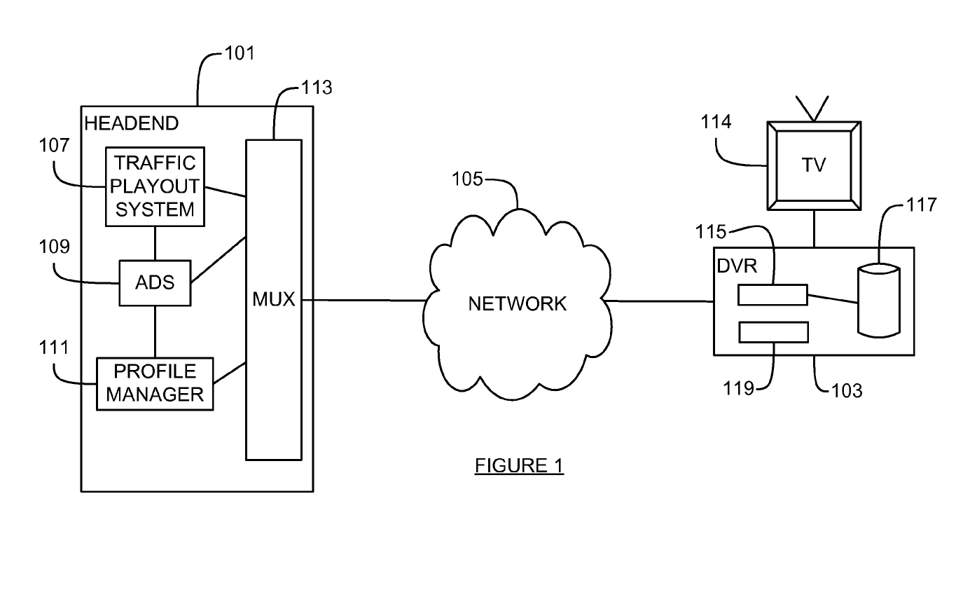

Reference is now made to FIG. 1, which shows a headend 101 that communicates with a digital video recorder DVR 103 via a one-way or two-way communication network 105 that includes at least one of the following: a satellite based communication network; a cable based communication network; a terrestrial broadcast television network; a telephony based communication network; a mobile telephony based communication network; an Internet Protocol (IP) television broadcast network; and a computer based communication network.

It is appreciated that in alternative embodiments, communication network 105 may, for example, be implemented by a one-way or two-way hybrid communication network, such as a combination cable-telephone network, a combination satellite-telephone network, a combination satellite-computer network, or by any other appropriate network.

Physical links in network 105 are implemented via optical links, conventional telephone links, radio frequency (RF) wired or wireless links, or any other suitable links.

It is appreciated that headend 101 may communicate with a plurality of DVRs 103 via communication network 105. Additionally, or alternatively, a plurality of headends 101 may communicate with a single DVR 103 or with a plurality of DVRs 103 via communication network 105. For simplicity of depiction and description, and without limiting the generality of the present invention, only one DVR 103 and a single headend 101 are illustrated in FIG. 1 and referred to below as communicating via communication network 105.

Headend 101 includes the following elements not all of which are essential to all of the embodiments described below: traffic playout system 107; advertisement decision system (ADS) 109; profile manager 111; and a multiplexer (MUX) 113. It is appreciated that headend 101 may include other elements not further described herein.

Traffic playout system 107 provides video and audio content (including programming that is separated by advertisements/commercials, and content metadata) in a format packaged for delivery via the MUX 113 to network 105.

ADS 109 performs assignment of profiles and advertisements to spots within avails, signalling of avails and profiles, and encoding of avails and profiles for delivery via the MUX 113 to network 105. (A spot is a time interval used in a broadcast for one or more advertisements/commercials; an avail is an opportunity for advertisement substitution comprising a time interval of consecutive spots; and a profile, within the context of an avail or a spot, is the conditions to be met for an advertisement substitution to be valid. Put another way, a profile (usually in the form of a profile attribute or a set of profile attributes linked by logical expressions) expresses the criteria that are used to define a target group of subscribers and determine if an advertisement substitution should take place.)

Profile manager 111 validates and stores user/device profiles for devices such as DVR 103. It also exposes an interface that enables the setting and modification of user/device profiles.

MUX 113 multiplexes video, audio and data provided by traffic playout system 107, ADS 109 and profile manager 111 and outputs multiplexed data for transmission to DVR 103 via network 105. It is appreciated that the transmissions may be transmitted either as out-of-band transmissions, such as data carousel transmissions, or as in-band transmissions, or any appropriate hybrid in-video and data carousel transmissions.

The transmissions are typically carried in a Moving Pictures Expert Group (MPEG) transport stream.

MPEG is an industry standard developed by the “Moving Pictures Expert Group” working group of the International Standards Organization (ISO) for video and audio source coding using compression and multiplexing techniques to minimize video signal bit-rate in preparation for broadcasting.

A transport stream (TS) is an MPEG multiplex with short fixed length packets carrying many programs intended for broadcast over potentially error-prone media, such as a satellite. A transport stream is a data structure defined in International Standard ISO/IEC 13818-1 (“Information technology—Generic coding of moving pictures and associated audio information: Systems”). It is the basis of the ETSI Digital Video Broadcasting (DVB), Advanced Television Systems Committee (ATSC) and ANSI Society of Cable Telecommunications Engineers (SCTE) standards. A TS may correspond to a single TV program, or multimedia stream. This type of TS is normally called a Single Programme Transport Stream (SPTS). An SPTS contains all the information required to reproduce the encoded TV channel or multimedia stream. In many cases, one or more SPTS streams are combined to form a Multiple Programme Transport Stream (MPTS). This larger aggregate also contains all the control information (Program Specific Information (PSI)) required to co-ordinate the DVB system, and any other data which is to be sent.

The multiplexed data are transmitted to DVR 103 via network 105 and received at an integrated receiver decoder (IRD) 115 in DVR 103. The IRD 115 is operable to receive, demultiplex, decode and decrypt/descramble as necessary the multiplexed data transmissions. DVR 103 also includes a high capacity storage device 117, such as a high capacity memory or disk, operatively associated with IRD 115.

DVR 103 records at least some of the transmissions received at the IRD 115 in the storage device 117 and displays recorded transmissions on television 114 at discretion of a user and at times selected by the user. It is appreciated that the recorded transmissions displayed by DVR 103 typically comprises transmissions delayed with respect to a time of broadcast of the transmissions by headend 101. Therefore, transmissions that undergo decoding, and if necessary decryption/descrambling at IRD 115, arrive either from broadcast transmissions broadcast by the headend 101, or from storage device 117 of DVR 103. The transmissions may, for example, be broadcast by headend 101 as regular scheduled transmissions or in the form of video-on-demand (VOD), near-video-on-demand (NVOD) or push-video-on-demand transmissions.

DVR 103 also stores avail schedules received at the IRD 115 in storage device 117. DVR 103 optionally also stores advertisements for use in advertisement substitution received at the IRD 115 in storage device 117.

DVR 103 also includes a processor 119, which typically includes an operating system that enables processing of the program transmissions.

It is appreciated that the elements of headend 101 and DVR 103 may be implemented in any appropriate combination of hardware and/or software. At least some of the elements comprising DVR 103 may be comprised in a single integrated circuit (IC).

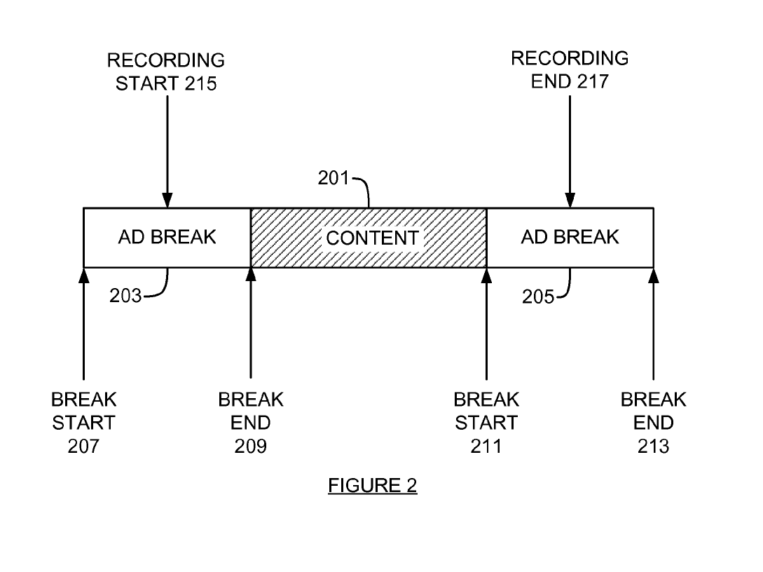

Referring now to FIG. 2, a typical transmission stream will now be described. Primary audio video content 201 is preceded by an advertisement break 203 (which comprises one or more advertisements) and succeeded by an advertisement break 205 (which comprises one or more advertisements). It is to be noted that there may be further advertisement breaks within primary content 201 but these are not shown for the sake of clarity.

Advertisement break 203 begins at break start point 207 and ends at break end point 209, and this is the point at which primary content 201 begins. Advertisement break 205 begins at break start point 211, and this is the point at which primary content 201 ends. Advertisement break 205 ends at break end point 213.

Signalling is provided within the headend transmissions to identify the position of the advertisement breaks within the transmission stream. ANSI/SCTE 35 2007 (“Digital Program Insertion Cueing Message for Cable”), included as Appendix A, defines an in-stream message mechanism used to signal splicing and insertion opportunities within an MPEG streams for the purpose of Digital Program Insertion, which includes advertisement insertion and insertion of other content types. The standard specifies a technique for carrying signalling data for notification of upcoming splice points and other timing information in an MPEG transport stream. The signalling data is typically delivered separately to the audio and video frames and therefore a common timeline is used to enable synchronisation of the audio/video stream and the signalling data stream.

Within an MPEG transport stream environment this timeline is typically provided by the PCR (Program Clock Reference), which is carried within the adaptation field of an MPEG transport stream packet (as described in the above mentioned ISO/IEC 13818-1 in Section 2.4.2.1). An elementary stream packet contains one or more frames of video and audio data. Associated with the elementary stream packet is a presentation time stamp (PTS) value, which announces the time at which the frame(s) is (are) to be presented to a user. The time is given in PCR samples.

Using the same PCR timeline mechanism, ANSI/SCTE 35 2007 signalling provides a mechanism to announce the start of an advertisement break (e.g. break start point 207/211) by announcing the PTS of the frame at which the advertisement break starts within the audio/video data stream (a splice is typically performed on a video frame boundary). As described in ANSI/SCTE 35 2007 in section 7, a splice_info_section for a splice information table is delivered on one or more PID stream(s) with the PID(s) declared in the program's PMT. The splice_info_section is delivered separately from the video and audio, using the MPEG private section syntax. The splice_info_section contains a splice_insert( ) command (as defined in section 7.3.3 of ANSI/SCTE 35 2007) which defines the PTS value of the splice point. DVR 103 is notified of the presence of the splice_info_section by a stream_identifier_descriptor being present within the elementary stream loop of the PMT (as described in section 6.3 of ANSI/SCTE 35 2007). It is to be noted that the PTS value announced is always greater than the PCR value currently valid within the transport stream due to a decoder delay which defines the period of time from reception of a frame to the actual presentation of a frame caused by encoded video frames being delivered out of sequence to improve encoding efficiency.

Typically the ANSI/SCTE 35 2007 signalling data includes the duration of the advertisement break (break_duration( ) as defined in section 7.4.2), and this can be used by DVR 103 to determine the actual PTS value at which the advertisement break finishes. Alternatively, explicit signalling of the end of advertisement break (e.g. break end point 209/213) may be provided by sending another ANSI/SCTE 35 2007 message a predetermined period of time before the end of the advertisement break.

As mentioned previously, ANSI/SCTE 35 2007 signalling data is used to signal the start of an advertisement break (e.g. break start point 207/211). ANSI/SCTE 35 2007 suggests in section 7.1 that the splice_insert( ) command signalling the start of an advertisement break could be delivered multiple times before the splice point, at 8, 5, 4 and 2 seconds prior to the packet containing the related splice point (i.e. prior to the start of the advertisement break.) No ANSI/SCTE 35 2007 signalling data is delivered after the advertisement break has started. Therefore if the end device tunes to the channel after the advertisement break has begun, or a recording were to commence during the advertisement break (e.g. at recording start 215), no ANSI/SCTE 35 2007 signalling data will be received.

According to embodiments of the present invention, the delivery of the ANSI/SCTE 35 2007 signalling data is extended for the entire lifetime of the advertisement break. Thus the ANSI/SCTE 35 2007 signalling data is delivered throughout the advertisement break so that if the end device tunes to the channel part way through the advertisement break this signalling data can still be received and the end device is able to determine the end of the advertisement break (splice point plus duration) and therefore the start of the main content. The ANSI/SCTE 35 2007 signalling data is also recorded and stored with the content in memory 117 (even if the advertisement has already commenced) so that if a recording commences during an advertisement break, the end device is able to determine the end of the advertisement break (splice point plus duration) and therefore the start of the main content. This is typically achieved by carouseling the same ANSI/SCTE 35 2007 signalling data at predetermined intervals (e.g. every second) throughout the advertisement break (e.g. advertisement break 203/205) on the same PID that was used to provide the ANSI/SCTE 35 2007 signalling data that signalled the start of the advertisement break (e.g. break start point 207/211).

In addition to the advertisement break signalling, for each advertisement break signalled, an avail definition may be delivered to DVR 103 that contains a sequence of rules to be evaluated at the point of playback. These rules define the behaviour of DVR 103 once the start and end of the content has been determined. These rules are typically delivered independently to the signalling since the rules could change even after the content itself has been delivered and/or after the content has been recorded. To enable the binding of rules to the signalling, a common identifier (e.g. availId) is typically provided within both the signalling and the rules. The rules may be delivered as a carousel within the delivery system; on demand at the point of playback; etc. The delivered rules are processed at the point of playback in the order in which they are defined, until one of the rules evaluates to true at which point the behaviour defined within the rule is executed. Any additional rules are not evaluated. In the present embodiment, avail definitions containing the rules are transmitted from headend 101 to DVR 103 in the form of an extensible markup language (XML) file. An example XML file showing at least a portion of an avail definition for advertisement break 203 is shown below:

```
<?xml version= “1.0”?>
  <avail availId=“458235802”>
    <duration>120</duration>
      <rule lessThanNdaysSinceRecording=“5” mode=“makegood”>
        <spot spotId=“12362” duration=“60”>
          <Ad duration=“60”>adId=“3473”</Ad>
        </spot>
        <spot spotId=“12363” duration=“60”>
          <Ad duration=“60” > adId=“3534”</Ad>
        </spot>
      </rule>
      <rule lessThanNdaysSinceRecording=“20” mode=targetedAds>
        <Profile>SportsLover</Profile>
          <spot spotId=“12362” duration=“60”>
            <Ad duration=“60”> adId=“5468”</Ad>
          </spot>
          <spot spotId=“12363” duration=“60”>
            <Ad duration=“60” > adId=“32453”</Ad>
          </spot>
      </rule>
      <rule olderThan=“2009-01-14T14:55:00” mode=“removeAds” />
        <Profile>GoldTierSubscriber</Profile>
      </rule>
</avail>
```

As can be seen in the XML code above, the avail definition is specified for a given avail identified using the availId. This availId is a common identifier that would also be provided within the signalling of advertisement break 203. A duration (typically in seconds) is specified for the avail. The avail specifies the rules which are to be evaluated at the point of playback and an operational mode to follow (behaviour to execute) if the rule evaluates to true.

Some examples of the behaviours defined by the rules delivered with the advertisement break signalling will now be described in more detail. In each of the examples that follow, it will be assumed that DVR 103 has recorded a recording and stored it in memory 117. Referring once again to FIG. 2, the recording starts at a recording start point 215, which falls within the middle of advertisement break 203, and ends at a recording end point 217, which falls within the middle of advertisement break 205. At the point of playing back the recording, since the advertisement break signalling has been repeatedly delivered during the lifetime of advertisement break 203 and stored with content 201 in memory 117, DVR 103 can locate the start of the primary content 201 by computing the PTS value for the end of the advertisement break (break end point 209). This is achieved by extracting the PTS value of the start of the advertisement break from memory 117, which is announced as part of the advertisement break signalling data, and adding the advertisement break duration time (also extracted from memory 229) to this PTS value. Alternatively, the PTS value for the end of the advertisement break (break end point 209) may have been explicitly announced as part of the advertisement break signalling data in which case it can be extracted from memory 117.

A rule may specify that advertisement break 203 and/or advertisement break 205 is/are not to be shown during playback of the recording. Since the PTS value for the start of primary content 201 has been determined, playback of the recording can be started from this point within the stored file. Since the start of advertisement break 205 (break start point 211) is signalled before the end of primary content 201, and stored with content 201 in memory 117, DVR 103 can use the PTS value for the start of advertisement break 205 and stop playback of the recording at this point within the stored file. Such a rule may further specify that advertisement break 203 and/or advertisement break 205 is/are not to be shown during playback of the recording if primary content 201 is more than a predetermined number of days old (which can be determined from the date on which primary content 201 was recorded/stored in memory 117) or is older than a date specified in the rule. The rule may further specify certain users who the rule is applicable to (e.g. certain levels of subscribers). By jumping to the start of the primary content when playback commences, the recording can effectively be ‘trimmed’ of an incomplete advertisement break to leave just the primary content.

In the example XML code above, the third rule specifies that if the current time (point of playback) is later than 2:55 pm on 14 Jan. 2009, then DVR 103 should operate in the “removeAds” mode for Gold Tier subscribers. Thus Gold Tier subscribers (who are in the ‘Gold Tier’ typically by virtue of the level of their subscription payments) will be able to view the primary content without viewing the advertisement break before the primary content.

As mentioned previously, DVR 103 optionally also stores advertisements, avails and profiles (for use in advertisement substitution) received at the IRD 115 in storage device 117. An operator may wish a viewer to see an advertisement break before and/or after viewing the primary content. However, in the embodiment described above, the recording starts at a recording start point 215, which falls within the middle of advertisement break 203, and ends at a recording end point 217, which falls within the middle of advertisement break 205. Thus some or all of one or more advertisements within advertisement break 203 and advertisement break 205 may not be seen by the viewer.

A rule may therefore specify that advertisement break 203 and/or advertisement break 205 be reconstructed so that the viewer is able to view advertisement break 203 and/or advertisement break 205 in its entirety. In order to implement such a rule, the contents of the avails that formed advertisement break 203 and advertisement break 205, and optionally the advertisements themselves, are delivered to DVR 103 along with the advertisement break signalling and stored in memory 117. A play list is generated that contains the primary content (starting from the PTS value for the end of advertisement break 203 and ending with the PTS value for the start of advertisement break 205 (determined according to the method described above) preceded by the advertisements that formed advertisement break 203 and/or followed by the advertisements that formed advertisement break 205. Thus the recorded incomplete advertisement breaks can be ‘made good’, or put another way, the recorded incomplete advertisement breaks can be reconstructed by substituting complete versions of the advertisement breaks, so that a viewer viewing the recording is able to view the complete advertisement break 203 and/or the complete advertisement break 205 even though the original recording did not include complete versions of advertisement break 203 and/or advertisement break 205. The advertisement(s) to be used in the reconstruction may be pre-stored in storage device 117 and/or may be fetched.

In the XML code above, the first rule specifies that the “makegood” behaviour, as described above, be executed if less than five days have elapsed since the recording. Two spots (having spotIds of 12362 and 12363) of 120s duration are specified. The spot with spotId 12362 specifies an advertisement of 60s duration having an adId of 3473. The spot with spotId 12363 specifies an advertisement of 60s duration having an adId of 3534. These spots and advertisements define the original broadcast advertisements that comprised advertisement break 203.

Such a rule could also specify that only certain advertisements that formed advertisement break 203 and advertisement break 205 be used in the reconstruction. For example, advertisements not recorded at all (i.e. those advertisements that aired in their entirety in advertisement break 203 before recording start point 215 (and/or those advertisements that aired in their entirety in advertisement break 205 after recording end point 217)) may be omitted from the reconstruction so that only the advertisement that was incomplete by starting the recording at recording start point 215 and subsequent advertisements (and/or the advertisement that was incomplete by stopping the recording at recording end point 217 and preceding advertisements), are reconstructed.

Instead of reconstructing the recorded incomplete advertisement break using the contents the contents of the avails that formed advertisement break 203 and advertisement break 205, a rule may specify that DVR 103 should construct an advertisement break to precede and/or follow primary content based on the profiles (advertisement substitution rules) stored in memory 117. In this way, an operator can use advertisement substitution to target advertisements at particular viewers. Methods of targeted advertisement substitution will be apparent to someone skilled in the art. The advertisement(s) to be used in the substitution may be pre-stored in storage device 117 and/or may be fetched.

In the XML code above, the second rule specifies that the “targetedAds” behaviour, as described above, be executed if less than twenty days have elapsed since the recording. Two spots (having spotIds of 12362 and 12363) of 120s duration are specified. The spot with spotId 12362 specifies an advertisement of 60s duration having an adId of 5468. The spot with spotId 12363 specifies an advertisement of 60s duration having an adId of 32453. It will be remembered that a profile expresses the criterion/criteria that is/are used to define a target group of subscribers and determine if an advertisement substitution should take place. The profile takes the form of a profile attribute (or a set of attributes linked by logical expressions). In this example, the rule specifies a profile of “SportsLover” (so that the substitution would only take place for a subscriber who enjoyed watching sports programming).

Instead of reconstructing the recorded incomplete advertisement break using the contents of the avails that formed advertisement break 203 and advertisement break 205, a rule may specify that DVR 103 should use some other content to precede and/or follow the primary content. Examples of other content may include content trailers, promotions, infomercials, broadcaster messages.

Another rule may specify that during playback of advertisement break 203 and/or advertisement break 205 (whether or not either or both has been reconstructed, with or without targeted advertisements) trick mode navigation (i.e. the ability for the viewer to view advertisements in a fast-forward or a fast-backward mode) is prohibited. Currently, trick mode prevention only works if the end user device is tuned to the channel broadcasting the advertisement when the advertisement commenced because the signalling to prevent trick mode operation is typically included as part of the rules associated with the advertisement break signalling. Thus, a rule that accompanied the advertisement break signalling throughout the duration of the advertisement would overcome this deficiency and therefore trick modes could be prevented even if a viewer tunes to a channel during an advertisement.

It will be apparent from the foregoing description that many modifications or variations may be made to the above described embodiments without departing from the invention. Such modifications and variations include:

Although the above embodiments were described in relation to advertisements and advertisement breaks, the processes described are equally applicable to other forms of content sub-items or interstitial content.

Although the above described embodiments were described using ANSI/SCTE 35 2007 signalling data, other signalling mechanisms that enable the synchronisation of data with a known timeline (e.g. MPEG PCR) are equally applicable. See, for example, ETSI TS 102 823 (Digital Video Broadcasting (DVB); Specification for the carriage of synchronized auxiliary data in DVB transport streams”). Moreover, the signalling mechanism described above is not limited to MPEG transport streams. In the case of content delivery over an internet protocol (IP) network, the Real-time Transport Protocol (RTP) along with the Real-time Transport Control Protocol (RTCP) (published by the Internet Engineering Task Force as Request for Comment (RFC) 2550) provides a similar mechanism for the synchronization of data with one or more components.

It is to be noted that the advertisement substitution described above can take place in either the transport (i.e. encoded) domain or in the presentation (i.e. unencoded) domain. In some embodiments, the term “playback” therefore includes the process of decoding rather than simply passing the decoded output of IRD 115 to television 114.

In the above described embodiments, the avail definitions were described as being transmitted from headend 101 to DVR 103 in the form of an extensible markup language (XML) file. In alternative embodiments, a specific binary encoding of the avail definitions could be transmitted instead in order to reduce the bandwidth requirements and to increase the speed at which the data can be parsed.

In the above described embodiments, the delivery of the ANSI/SCTE 35 2007 signalling data is extended for the entire lifetime of the advertisement break. In other embodiments, the delivery of the signalling data may be further extended for a predetermined period into a content item following the advertisement break. For example, the signalling data for advertisement break 203 may be delivered one or more times after the splice point. This is useful in a situation where recording start point 215 occurred close to break end point 209 but after the last carouselled message of advertisement break 203 that carried the advertisement break signalling data.

It is appreciated that software components of the present invention may, if desired, be implemented in ROM (read only memory) form. The software components may, generally, be implemented in hardware, if desired, using conventional techniques. It is further appreciated that the software components may be instantiated, for example: as a computer program product; on a tangible medium; or as a signal interpretable by an appropriate computer.

It is appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable subcombination.

It will be appreciated by persons skilled in the art that the present invention is not limited by what has been particularly shown and described hereinabove. Rather the scope of the invention is defined only by the claims which follow:

### APPENDIX A

1. A method of receiving content at a user unit, said method comprising:
receiving at said user unit a transmission stream, said transmission stream comprising: (a) a content item followed by a following interstitial content set, said following interstitial content set comprising one or more following interstitial content items, and (b) following start time data indicating a following start point of said following interstitial content set, wherein said following start time is received in advance of said following start point during reception of said content item; and
continuing to receive said following start time data periodically throughout reception of said following interstitial content set.

2. The method of claim 1, wherein said transmission stream further comprises: (c) following duration data, said following duration data indicating a following duration of said following interstitial content set, and said method further comprises: continuing to receive said following duration periodically throughout reception of said following interstitial content set.

3. The method of claim 2, wherein said transmission stream further comprises: (aa) a preceding interstitial content set, said preceding interstitial content set comprising one or more preceding interstitial content items, said preceding interstitial content set being received before said content item, and (bb) preceding start time data indicating a preceding start point of said preceding interstitial content set, wherein said preceding start time is received in advance of said preceding start point during reception of a preceding content item, said preceding content item preceding said preceding interstitial content set, and said method further comprises: continuing to receive said preceding start time data periodically throughout reception of said preceding interstitial content set.

4. The method of claim 3, and further comprising:
receiving said preceding start time data at the start of reception of said content item.

5. The method of claim 3, wherein said transmission stream further comprises: (cc) preceding duration data, said preceding duration data indicating a preceding duration of said preceding interstitial content set, and said method further comprises: continuing to receive said preceding duration periodically throughout reception of said preceding interstitial content set.

6. The method of claim 5, and further comprising:
receiving said preceding duration data at the start of reception of said content item.

7. The method of claim 5, and further comprising:
making a recording at said user unit by storing a portion of said preceding interstitial content set, said content item and a portion of said following interstitial content set, wherein said recording starts at a recording start point during reception of said preceding interstitial content set and ends at a recording end point during reception of said following interstitial content set; and
storing said preceding start time data, said preceding duration data, said following start time data and said following duration data.

8. The method of claim 7, and further comprising:
determining a content item start time by extracting said preceding start time data and said preceding duration data, and adding said preceding start time data to said preceding duration data to obtain said content item start time.

9. The method of claim 8, and further comprising:
playing back said recording starting from said content start time.

10. The method of claim 8, and further comprising:
determining a content item end time by extracting said following start time data and designating said following start time data as said content item end time.

11. The method of claim 10, and further comprising:
stopping playing back said recording at said content item end time.

12. The method of claim 7, and further comprising:
receiving at said user unit one or more substitution interstitial content items;
playing back one or more substitution interstitial content items; and
subsequently playing back said recording starting from said content start time.

13. The method of claim 12, wherein said one or more substitution interstitial content items correspond to said preceding interstitial content items in said preceding interstitial content set.

14. The method of claim 11, and further comprising:
receiving at said user unit one or more substitution interstitial content items; and
playing back one or more substitution interstitial content items after playing back said recording.

15. The method of claim 14, wherein said one or more substitution interstitial content items correspond to said following interstitial content items in said following interstitial content set.

16. The method of claim 12, and further comprising:
receiving said one or more substitution interstitial content items in advance; and
storing said one or more substitution interstitial content items.

17. The method of claim 7, and further comprising:
receiving at said user unit at least one rule defining how said recording is to be played back.

18. A method of transmitting content to a user unit, said method comprising:
transmitting to said user unit a transmission stream, said transmission stream comprising: (a) a content item followed by a following interstitial content set, said following interstitial content set comprising one or more following interstitial content items, and (b) following start time data indicating a following start point of said following interstitial content set, wherein said following start time is transmitted in advance of said following start point during transmission of said content item; and
continuing to transmit said following start time data periodically throughout transmission of said following interstitial content set.

19. The method of claim 18, wherein said transmission stream further comprises: (c) following duration data, said following duration data indicating a following duration of said following interstitial content set, and said method further comprises: continuing to transmit said following duration periodically throughout transmission of said following interstitial content set.

20. The method of claim 19, wherein said transmission stream further comprises: (aa) a preceding interstitial content set, said preceding interstitial content set comprising one or more preceding interstitial content items, said preceding interstitial content set being transmitted before said content item, and (bb) preceding start time data indicating a preceding start point of said preceding interstitial content set, wherein said preceding start time is transmitted in advance of said preceding start point during transmission of a preceding content item, said preceding content item preceding said preceding interstitial content set, and said method further comprises: continuing to transmit said preceding start time data periodically throughout transmission of said preceding interstitial content set.

21. The method of claim 20, and further comprising:
transmitting said preceding start time data at the start of transmission of said content item.

22. The method of claim 21, wherein said transmission stream further comprises: (cc) preceding duration data, said preceding duration data indicating a preceding duration of said preceding interstitial content set, and said method further comprises: continuing to transmit said preceding duration periodically throughout transmission of said preceding interstitial content set.

23. The method of claim 22, and further comprising:
transmitting said preceding duration data at the start of transmission of said content item.

24. The method of claim 1, wherein said interstitial content items comprise advertisements.

25. The method of claim 18, wherein said interstitial content items comprise advertisements.
